(19) United States
(12) Patent Application Publication
(10) Pub. No.: US 2026/0088603 A1
(43) Pub. Date: Mar. 26, 2026

(54) PROTECTIVE DEVICES AND METHODS FOR PROTECTION AGAINST ELECTRIC SHOCK IN A POWER SUPPLY SYSTEM HAVING MULTIPLE POWER SOURCES

(71) Applicant: Bender GmbH & Co. KG, Gruenberg (DE)

(72) Inventors: Dieter Hackl, Fernwald (DE); Dennis Haub, Langgoens (DE)

(73) Assignee: Bender GmbH & Co. KG, Gruenberg (DE)

(21) Appl. No.: 19/335,070

(22) Filed: Sep. 22, 2025

(30) Foreign Application Priority Data
Sep. 23, 2024 (DE) 10 2024 127 466.2

(51) Int. Cl. H02H 3/32; H02H 1/00; H02H 3/00; H02H 3/093

(52) U.S. Cl. CPC H02H 3/32; H02H 1/0007; H02H 3/006; H02H 3/093

(57) ABSTRACT

The present disclosure relates to protective devices and methods for protection against electric shock in an AC, 3AC or DC power supply system, which has a main supply and additional power sources. In a first embodiment, a voltage measuring device is switched at each of the additional power sources. A signaling device disposed at the additional power sources signals when a voltage is exceeded by means of a disconnect signal should the measured voltage exceed a voltage threshold at the corresponding additional power source. A second embodiment comprises a residual current device disposed at each of the additional power sources and intended for identifying a corresponding residual differential current, and a measuring impedance switched at the additional power sources and intended for generating the residual differential current.

### CROSS-REFERENCE TO RELATED APPLICATION

The present application claims the benefit of priority to German Patent Application No. 10 2024 127 466.2, entitled “Schutzvorrichtungen und Verfahren für den Schutz gegen elektrischen Schlag in einem Stromversorgungssystem mit mehreren Energiequellen” and filed Sep. 23, 2024, the entire contents of which are incorporated herein by reference.

### TECHNICAL FIELD

The present disclosure relates to protective devices and methods for protection against electric shock in an AC, 3AC, or DC power supply system having a main supply and additional power sources, an N conductor or an M conductor connected to a protective conductor with low resistance at the main supply.

### BACKGROUND

The basis for the observations is a power supply system which has a network configuration in which an active conductor (N conductor in an AC, 3AC power supply system or M conductor in a DC power supply system) is connected to the protective conductor with low resistance. In this context, the term “low resistance” covers all types of power supply systems in accordance with the standard IEC60364-1:2005, section “312.2 Types of system earthing”.

### BRIEF DESCRIPTION OF THE DRAWINGS

FIG. 1 depicts an AC power supply system having a main supply and a central grounding point according to one or more aspects shown and described herein;

FIG. 2 depicts the AC power supply system having additional power sources according to one or more aspects shown and described herein;

FIG. 3 depicts the AC power supply system in the event of a ground fault according to one or more aspects shown and described herein;

FIG. 4A depicts the AC power supply system in the event of a ground fault with a residual current device at the main supply according to one or more aspects shown and described herein;

FIG. 4B depicts the AC power supply system in the event of a ground fault with a residual current device at the additional power sources according to one or more aspects shown and described herein;

FIG. 5A depicts the AC power supply system in the event of a ground fault and interruption of the N conductor during the main supply (FIG. 5a) according to one or more aspects shown and described herein;

FIG. 5B depicts the AC power supply system in the event of a ground fault and interruption of the N conductor when supplied exclusively by additional power sources according to one or more aspects shown and described herein;

FIG. 6A depicts the AC power supply system in the event of a ground fault with a protective device in a first embodiment when supplied exclusively by additional power sources without interruption of the N conductor;

FIG. 6B depicts the AC power supply system in the event of a ground fault with a protective device in a first embodiment when supplied exclusively by additional power sources with a central interruption of the N conductor;

FIG. 7 depicts the AC power supply system in the event of a ground fault with a protective device in a first embodiment when supplied exclusively by additional power sources with partial interruption of the N conductor;

FIG. 8 depicts the AC power supply system in the event of a ground fault with a protective device in a second embodiment when supplied exclusively by additional power sources with partial interruption of the N conductor; and

FIG. 9 depicts the AC power supply system in the event of a ground fault with a protective device in a second embodiment during the main supply and when supplied by additional power sources.

### DETAILED DESCRIPTION

The power supply system under consideration represents a prerequisite, exemplary application environment for the protective devices according to the present disclosure and their underlying methods, but is not part of the subject matter of the claims.

Relevant installation standards require that the low-resistance connection to the protective conductor may only be made at a central point, the central grounding point, in order to prevent part of the load current from flowing permanently through the protective conductor.

Protection against electric shock in electrical installations is normatively ensured by means of suitable combinations of basic protection and fault protection.

The protective measure for basic protection prevents direct physical contact with live active parts of the electrical installation, e.g., through insulation or a housing. The protective measure for fault protection prevents a dangerous contact voltage from occurring and/or remaining in the event of a fault.

Under certain conditions of external influences and in special areas, measures for additional protection are provided for electrical installations and equipment in addition to the protective measures for basic protection and fault protection. In particular, this additional protective measure can be ensured in accordance with the standard IEC 60364-4-41—corresponding to the standard DIN VDE 0100-410 in section 415.1—by using a residual current device (RCD) with a nominal tripping current ≤30 mA.

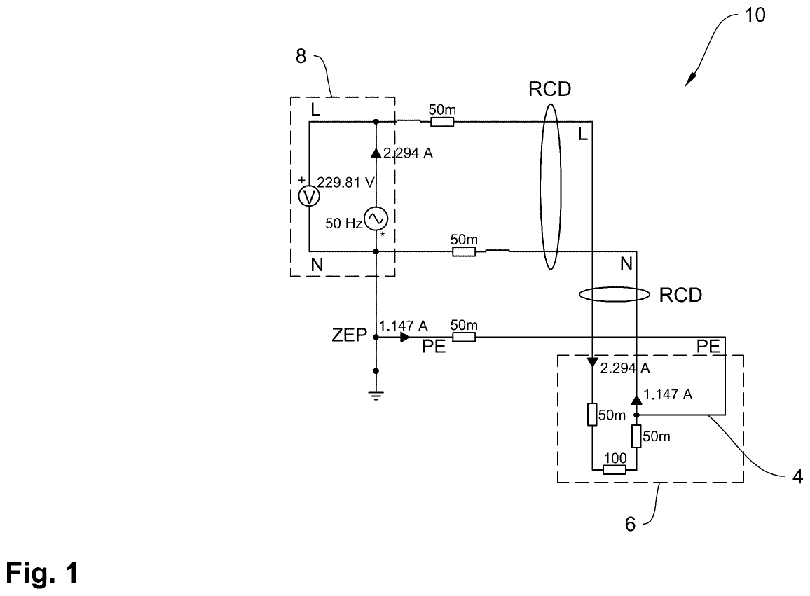

As described hereinbelow, FIGS. 1, 2, 3, 4A, 4B, 5A and 5B show simulation results of the current and voltage distribution for different fault cases in an exemplary AC power supply system 10 which is grounded via a central grounding point ZEP and has a main supply 8 and additional power sources 12.

FIG. 1 shows that in the AC power supply system 10, approximately half of the load current of a consumer 6 flows continuously via the protective conductor PE if, in addition to the central grounding point ZEP, an additional low-resistance connection 4 is present at the consumer 6 between the N conductor and the protective conductor PE. However, a residual current device RCD installed on the main supply 8 or on the consumer 6 would detect the (faulty) connection of the N conductor to the protective conductor PE on the consumer 6 and immediately trip.

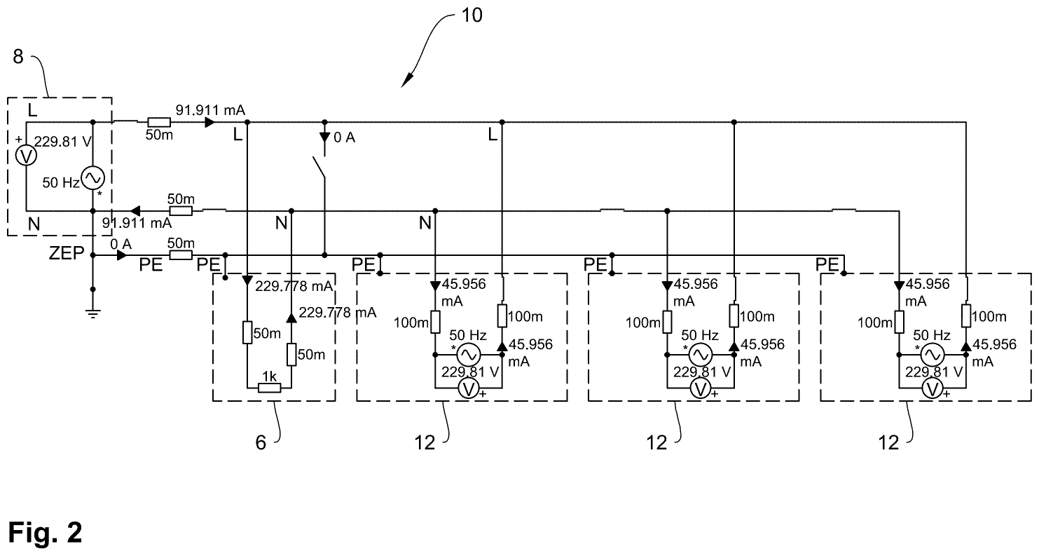

Power supply systems 10 deserve special consideration, as they not only have energy sinks (consumers 6) as operating equipment, but also additional power sources 12 (FIG. 2) in addition to the main supply 8. The installation standards also apply to this design of power supply systems 10, requiring that a connection between the N/M conductor and the protective conductor PE may only be established at the central grounding point ZEP.

Other power sources 12 which feed energy into the system at least temporarily include, for example, a PV system (PV inverter), a bidirectional charging station for an electric vehicle (EV), or an electrical energy storage system (EES).

FIG. 2 shows such a power supply system 10—initially fault-free—with a corresponding power distribution.

A characteristic feature of this configuration of the power supply system 10 in a fault-free state is the distribution of the load current flowing through the consumer 6 to all active power sources 8, 12 (main supply 8 and additional power sources 12). The distribution of the load current is essentially determined by the ratio of the internal resistances of the power sources 8, 12 and the distribution of the line resistances. The internal resistances of the other power sources 12, in turn, are specified, for example, by the control strategies of the inverters used.

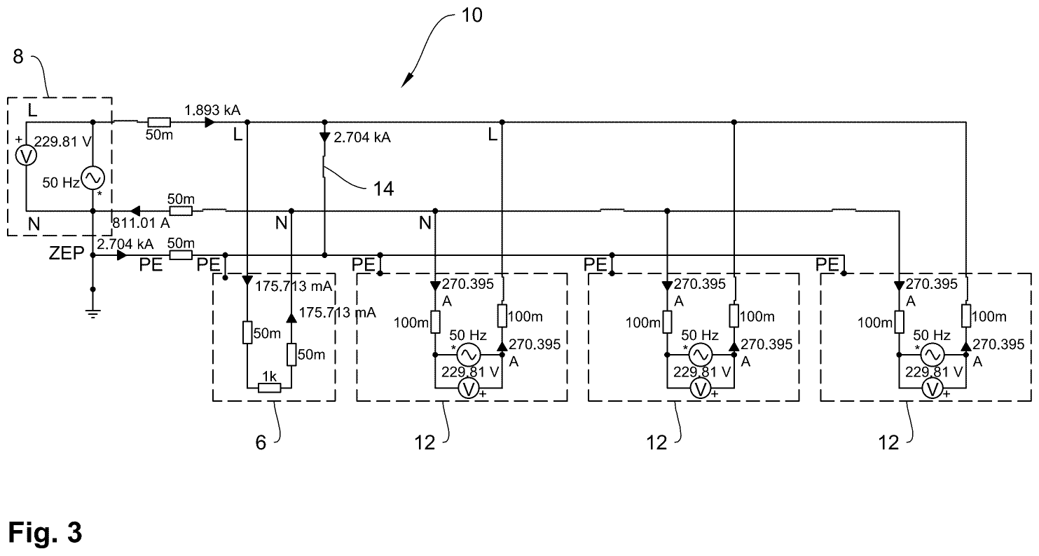

If, as shown in FIG. 3, a fault in the form of a ground fault 14 occurs in the main system of such a power supply system 10, a number of special features must be taken into account.

The total earth fault current (earth fault current via earth fault 14) driven by the main supply 8 and the additional power sources 12 is distributed among the active power sources 8, 12 available in the system. As with load current distribution, earth fault current distribution also depends on the ratio of internal resistances and the distribution of line resistances. As long as the main supply 8 is active, it can be assumed that the majority of the earth fault current is caused by the main supply 8.

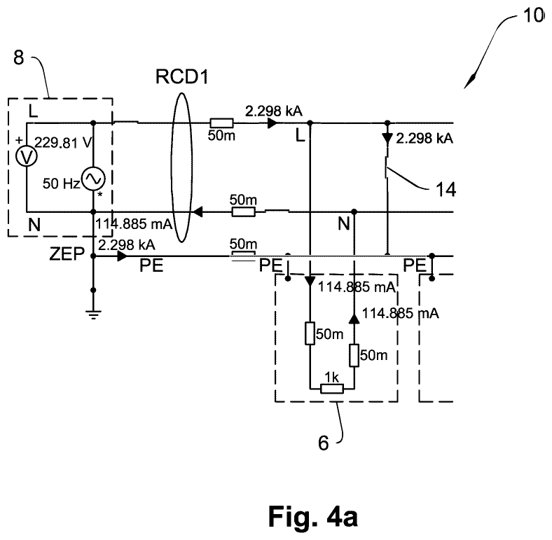

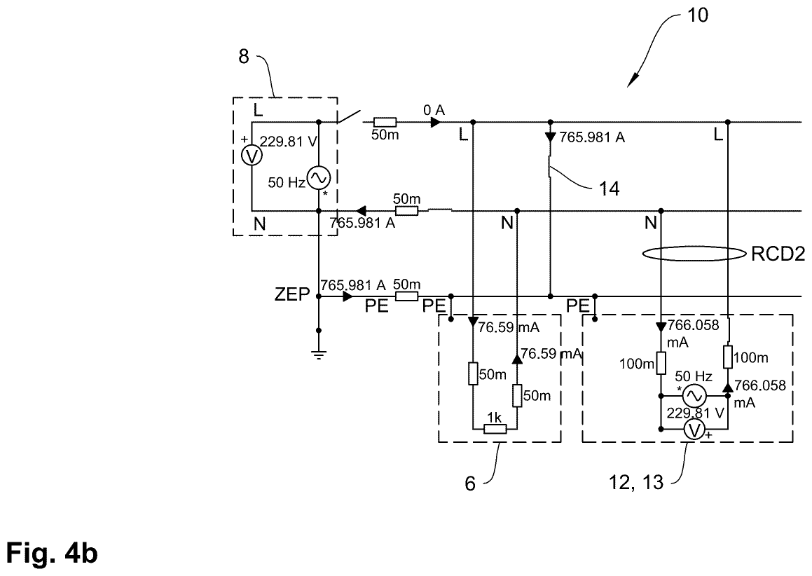

Based on the fault case (ground fault 14) shown in FIG. 3, the result is now, as shown in FIG. 4A and FIG. 4B, another special feature presents itself in connection with a residual current device RCD1 (FIG. 4A) installed on the main supply 8 and a residual current device RCD2 installed on the corresponding additional power sources 12 (FIG. 4B).

As shown in FIG. 4A, as expected, the ground fault 14 causes a differential current in the main supply 8, the differential current being detected by the residual current device RCD1 and leading to the main supply 8 being disconnected.

After disconnecting the main supply 8, the ground fault 14 continues to be fed by the PV inverter 13 as an (exemplary) additional power source 12 (FIG. 4B). If the N conductor is intact, no differential current is formed at the connection of the PV inverter 13. On the side of the PV inverter 13, no current difference is formed between the N conductor and the L conductor, meaning the ground fault current continues via the protective conductor PE, the central grounding point ZEP and the (intact) N conductor due to the position of the central grounding point ZEP on the main supply 8. This means that the residual current device RCD2 installed on the PV inverter 13 is not tripped.

The use of a residual current device RCD2 on the PV inverter 13, and generally on additional power sources 12, such as bidirectional EV charging stations and electrical energy storage devices, therefore does not offer any additional protection through the use of a residual current device RCD2 as required by the above-mentioned standard.

However, an overcurrent protection device installed on the PV inverter 13 will automatically shut off the power supply.

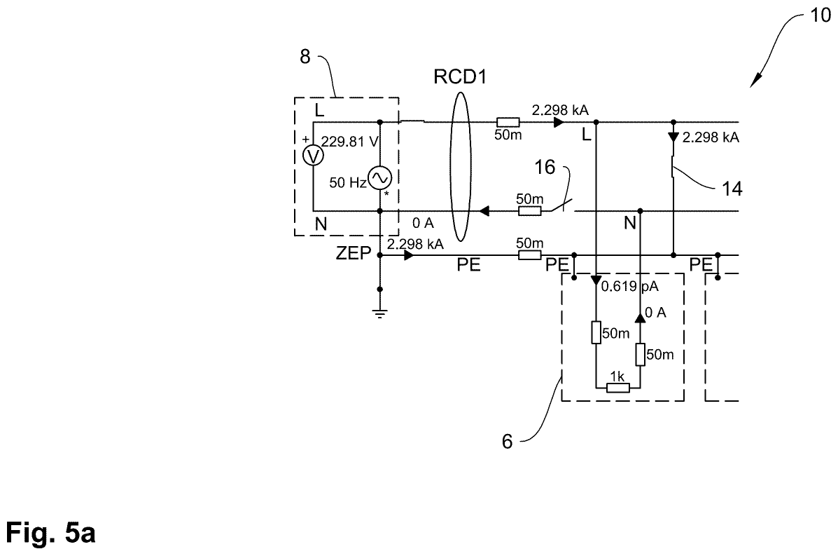

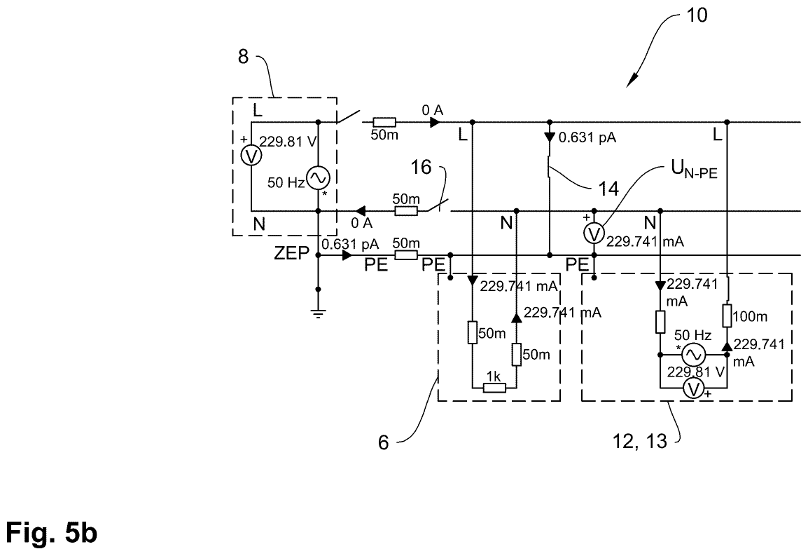

Until now, a functional (intact) N conductor has been presumed. If, as shown in FIG. 5A, an interruption 16 of the N conductor occurs in the underlying power supply system 10, the additional protection provided by a residual current device RCD1 at the main supply continues to function reliably even if there is an earth fault 14 in the main system, as the residual current device RCD1 installed at the main supply 8 identifies a differential current as a result of the displacement of the fault current from the N conductor (enclosed by the measuring current transformer of the residual current device RCD1) to the protective conductor PE (not enclosed by the measuring current transformer).

If, on the other hand, the interruption 16 occurs at the N conductor when, as shown in FIG. 5B, the feed is provided exclusively by one or more of the additional power sources 12, the shutdown by an overcurrent protection device intended in the protective measure “Automatic shutdown of the power supply” at the additional power sources 12 no longer works in the earth fault case 14 shown, as the required tripping current is too low—compare this with FIG. 4B, in which a sufficiently high current flow via the PV inverter 13 can be seen, which leads to the automatic shutdown of the power supply by the overcurrent protection device.

As a result of the earth fault 14, an interruption 16 of the N conductor causes the voltage between the N conductor and earth (N-conductor-to-protective-conductor voltage UN-PE) to shift towards the full (external) conductor voltage (phase-to-phase voltage). If the operating equipment is not designed for this voltage, continued operation of the electric installation can lead to damage and increase the risk of fire.

A solution known from the state of the art and commonly used in basic safety standards is to provide protective equipotential bonding in addition to the protective grounding system. This is an expensive measure and does not protect against the voltage between the N conductor and the protective conductor shifting towards the full phase-to-phase nominal voltage with the effects described above.

A frequently discussed approach is to switch the central grounding point when the energy flow from the main supply is switched off. This is not permitted by the standards.

One option provided in the corrosion protection of pipelines and DC traction power supplies is to connect active conductors to ground multiple times via antiparallel diode strings.

Finally, another approach uses a communication or trigger line between the protective devices of all operating equipment and the main supply. If a critical condition is then detected at one location in the system, all protective devices are triggered.

In summary, it can be said that none of the currently known approaches leads to a technically satisfactory and economically viable solution.

The object of the present disclosure at hand is therefore to provide new protective measures for electrical safety as an additional protection measure for an AC, 3AC, and DC power supply system having a main supply and additional power sources and having a central grounding point ZEP.

In a first embodiment, this object is attained by a voltage measuring device being switched between the N conductor or M conductor and the protective conductor at each of the additional power sources and being intended for measuring an N-conductor-to-protective-conductor voltage U_{N-PE} or an M-conductor-to-protective-conductor voltage U_{M-PE} and by a signaling device disposed at each of the additional power supplies and intended for signaling when a voltage has been exceeded by means of a disconnect signal should the N-conductor-to-protective-conductor voltage U_{N-PE} or the M-conductor-to-protective-conductor voltage U_{M-PE} exceed a voltage threshold at the corresponding additional power supply.

As elements essential to the present disclosure, the protective device according to the present disclosure comprises the arrangement of the voltage measuring device and the signaling device in this first embodiment.

The N-conductor-to-protective-conductor voltage or M-conductor-to-protective-conductor voltage measured by the voltage measuring device at the respective additional power source is evaluated in the signaling device with regard to its magnitude. If the measured voltage value exceeds a pre-settable voltage limit value, this voltage exceedance is then detected by the signaling device and signaled by means of a disconnect signal. The disconnect signal can be used to control a disconnecting device or to activate further normatively prescribed protective measures.

In a further design, a disconnect device which is disposed at each of the additional power supplies is connected to the corresponding signaling device in order to receive the disconnect signal.

The disconnecting device receives the disconnect signal sent by the signaling device in the event a voltage is exceeded and thus disconnects the corresponding additional power source.

In a second embodiment, in conjunction with a residual current device (RCD) disposed at each of the additional power sources and intended for identifying a corresponding residual differential current, the object is attained in that a measuring impedance which is intended for generating the residual differential current caused by an N-conductor-to-protective-conductor voltage U_{N-PE} or an M-conductor-to-protective-conductor voltage U_{M-PE} is switched between the N conductor or the M conductor and the protective device at each of the additional power sources.

The N-conductor-to-protective-conductor voltage or M-conductor-to-protective-conductor voltage which both occur in the event of a fault is converted into an evaluable residual differential current by means of a measuring impedance connected between the N conductor or M conductor and the protective conductor in accordance with the present disclosure. This residual differential current is identified by the residual current device disposed at the other power source in accordance with the present disclosure and ensures that this residual current device can be used as an additional protective measure to disconnect the other power source to be protected.

To fulfill the RCD function, a residual current monitoring device (RCM) having an external switching element or a modular residual current device (MRCD) can be installed instead of the residual current device.

In a further embodiment, the measuring impedance and a protective-conductor connection are integral components of the residual-current device.

By using a residual current device which has been modified in this manner and has been extended the measuring impedance and the protective conductor connection, the evaluable residual differential current can be realized in a compact structural design.

Preferably, the measuring impedance is greater than a fault-loop impedance and less than a quotient derived from an admissible touch voltage and a nominal tripping current of the residual current device.

This ensures that, on the one hand, the residual differential current flowing via the measuring impedance does not act as an additional fault current. On the other hand, the residual differential current must be sufficiently large to trigger the residual current device.

Furthermore, the protective device in the second embodiment may have a time-slot control which cyclically activates the measuring impedances in temporal intervals.

Particularly in extensive power supply systems with a large number of measuring impedances to be introduced according to the present disclosure between the N conductor or M conductor and the protective conductor, it is proposed to activate these cyclically in a time-slice method in order to avoid an excessive protective conductor current in the overall system.

The activation can take place in particular in conjunction with the modified residual current device, which is equipped with the protective conductor connection and the measuring impedance integrated on the operating-equipment side.

The design of the protective devices as described above and intended by the present disclosure is based on the procedural teachings described in the corresponding independent method claims. In this respect, the aforementioned technical effects and resulting advantages also apply to the method features.

The present disclosure enables continuous additional (fault) protection in AC, 3AC, and DC power supply systems having a central grounding point and having operational equipment which functions as a power source. In compliance with present basic safety standards and installation standards, the protective measures required by the standards for basic protection and fault protection are supplemented with regard to the future increasing prevalence of feed-capable operating equipment, meaning the application of the additional protective measures is not limited to special applications. In particular, the proposed measures can be integrated into the converters of the connected feed-back-capable operating equipment. In a specially designed construction, the converter has the measuring impedance and the protective conductor connection for this purpose.

The protective devices according to the present disclosure can also be integrated into residual current devices (RCD), modular residual current devices (MRCD), or residual current monitoring devices (RCM).

Further advantageous embodiment features are derived from the following description and the drawings, which describe an embodiment of the present disclosure by means of examples.

As explained in the introduction, FIGS. 1, 2, 3, 4A, 4B, 5A, and 5B show simulation results of the current distribution and voltage distribution as an example for an AC power supply system 10 grounded via a central grounding point ZEP and having a main supply 8 and additional power sources 12. A ground fault 14 and a central interruption 16 of the N conductor occur as fault cases. The partially inadequate protective measures in different fault constellations (caused by the earth fault 14 and the interruption 16 of the N conductor) and operating states (caused by the main supply 8 and the supply from additional power sources 12) lead to the object mentioned above of providing new protective measures for electrical safety.

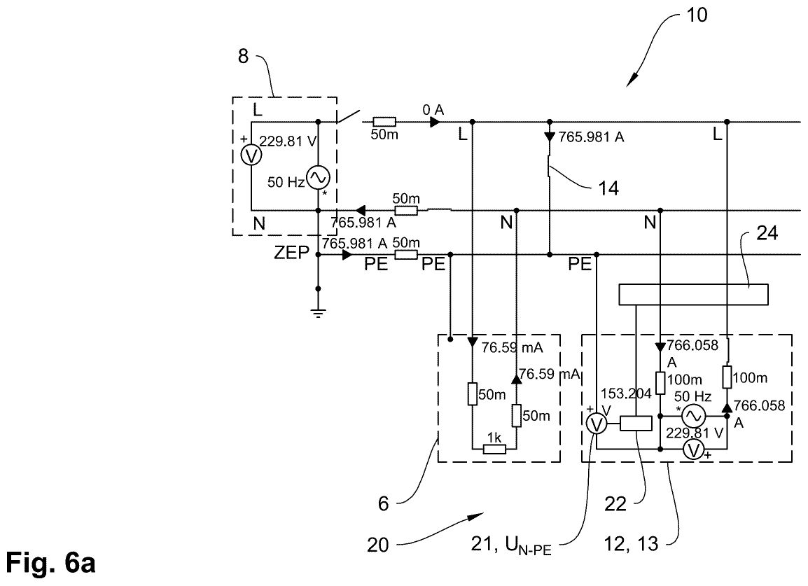

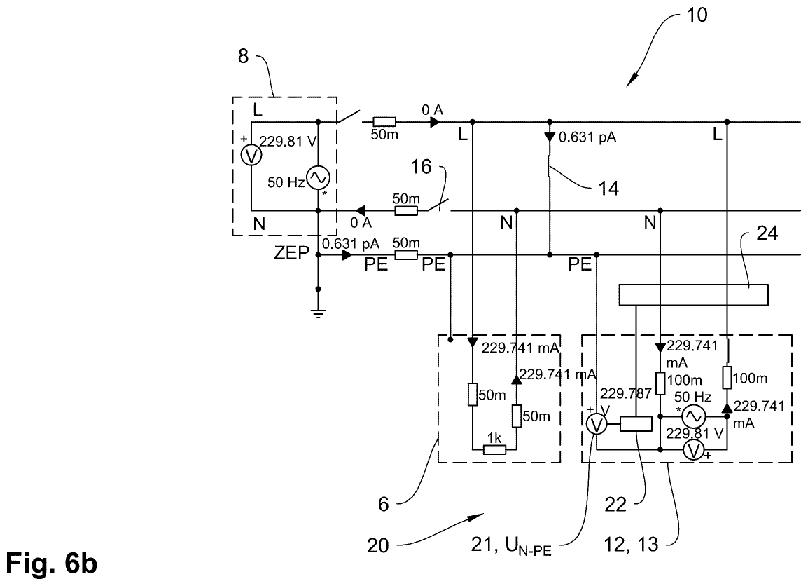

The further illustrations in FIGS. 6A, 6B, 7, 8, and 9 refer to the protective devices according to the present disclosure and the underlying method according to the present disclosure.

FIGS. 6A and 6B show the AC power supply system 10 in the event of a ground fault 14 with the protective device according to the present disclosure in the first embodiment 20 when supplied exclusively by additional power sources 12.

According to the present disclosure, a voltage measuring device 21 for measuring an N-conductor-to-protective-conductor voltage U_{N-PE} is switched between the N conductor and the protective conductor PE. Both for the earth fault 14 with intact N conductor (FIG. 6A) and for the earth fault 14 with central interruption 16 of the N conductor (FIG. 6B), an N-conductor-to-protective-conductor voltage U_{N-PE} detected by the voltage measuring devices 21 occurs at the PV inverter 13 acting as an additional power source 12, the N-conductor-to-protective-conductor voltage U_{N-PE} being significantly greater than a maximally admissible fault voltage (touch voltage) of 50 V. In a signaling device (22) disposed at the additional power sources (12) as intended by the present disclosure, the N-conductor-to-protective-conductor voltage U_{N-PE} is evaluated and the voltage exceedance is detected.

The measurement and evaluation of the N-conductor-to-protective-conductor voltage U_{N-PE} can be used to automatically disconnect the PV inverter 13 by means of a disconnecting device 24 or to activate further normatively prescribed protective measures, thus providing additional protection.

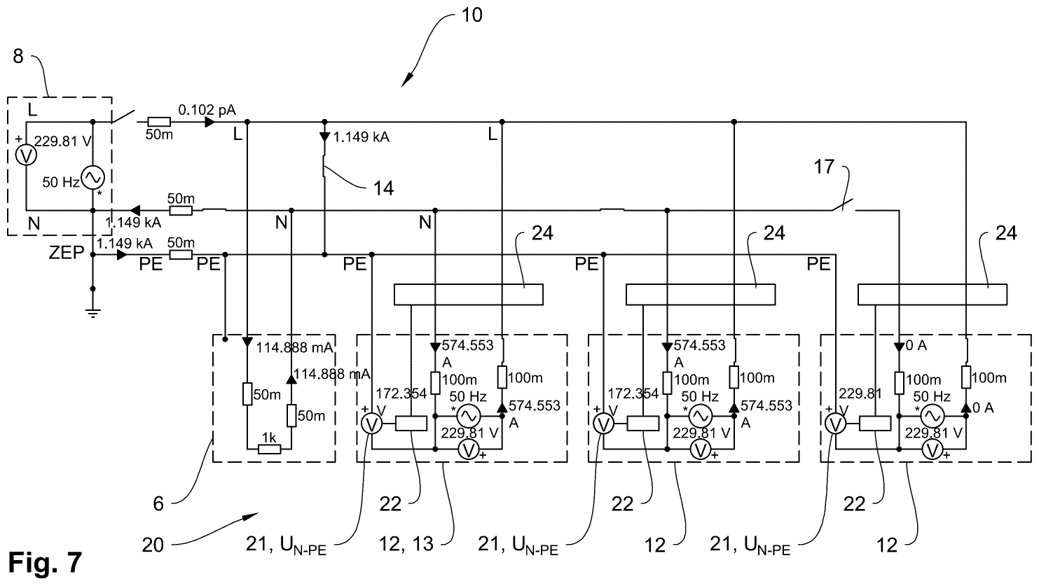

FIG. 7 shows the AC power supply system 10 in the event of a ground fault 14 with the protective device according to the present disclosure in the first embodiment 20 when supplied exclusively by additional power sources 12 with partial interruption 17 of the N conductor.

In this case, the protective device according to the present disclosure in the first embodiment 20 comprises the voltage measuring device 21, the signaling device 22 and the disconnecting device 24 at each additional power source 12 in this instance.

The voltage distribution shows that, even with only a partial interruption 17 of the N conductor, the N-conductor-to-protective-conductor voltage U_{N-PE} at all other power sources 12 in the AC power supply system 10 is significantly greater than the maximally admissible fault voltage of 50 V. Thus, the measured N-conductor-to-protective-conductor voltage U_{N-PE} can also serve here as an indicator for disconnecting the corresponding power source or for initiating further protective measures.

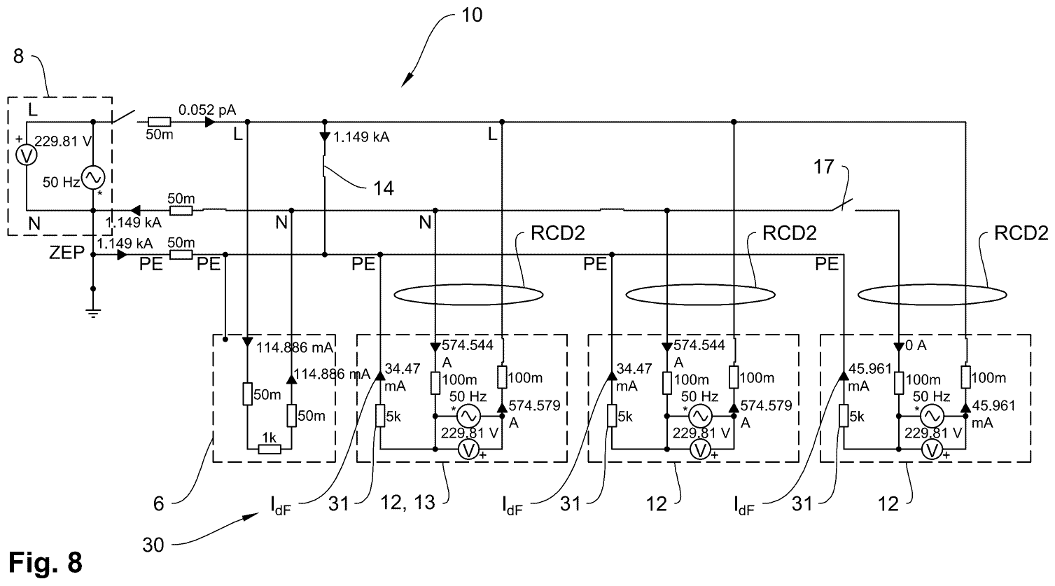

FIG. 8 shows the AC power supply system 10 in the event of a ground fault 14 with the protective device in the second embodiment 30 as intended by the present disclosure when supplied exclusively by additional power sources 12 with partial interruption 17 of the N conductor.

At each of the additional power sources 12, a measuring impedance 31 is switched between the N conductor and the protective conductor PE in accordance with the present disclosure, the measuring impedance 31 converting the N conductor-to-protective conductor voltage U_{N-PE} into an evaluable residual differential current I_{dF}.

The simulation results show that a correctly dimensioned measuring impedance 31 at the corresponding additional power source 12 generates a residual differential current I_{dF} in the event of a fault, the residual differential current I_{dF} being able to trigger the residual current device RCD2 disposed at the corresponding additional power source 12 in accordance with the present disclosure.

The effect that, in the case of multiple low-resistance connections of the N conductor (M conductor in DC systems) to the protective conductor PE—for example, an earth fault 14 as a low-impedance connection is present in addition to the central grounding point ZEP—part of the load current flows via the protective conductor PE and triggers the residual current device RCD2 even in a fault-free state, is not to be expected with the protective device in the second embodiment 30 as intended by the present disclosure if the measuring impedance 31 inserted between the N conductor (M conductor in DC systems) and protective conductor PE is correctly configured at the other power sources 12.

If, according to the present disclosure, the power supply 10 is to be automatically disconnected by residual current devices RCD2, the following dimensioning requirements for the measuring impedances 31 between the N conductor (M conductor in DC systems) and the protective conductor PE must be observed:

The impedance value (ohmic resistance value in DC systems) must be much greater than the fault-loop impedance. In the simulated example, a factor of 10000 was achieved.

The impedance value (ohmic resistance value in DC systems) must be less than the quotient derived from an admissible touch voltage U_{B} and a nominal tripping current I_{dn} of the residual current device RCD2: |Z_{N-PE}|<U_{B}/I_{dn}, for example less than 50 V/30 mA.

According to the present disclosure, if the N-conductor-to-protective-conductor voltage U_{N-PE} between the N conductor and protective conductor PE in the converter is meant to trigger protective measures in accordance with IEC 60364-4-41 Annex D.2, it is sufficient to configure the impedance value to be as high as possible, but sufficiently low to avoid false reactions, e.g., due to low capacitive coupling.

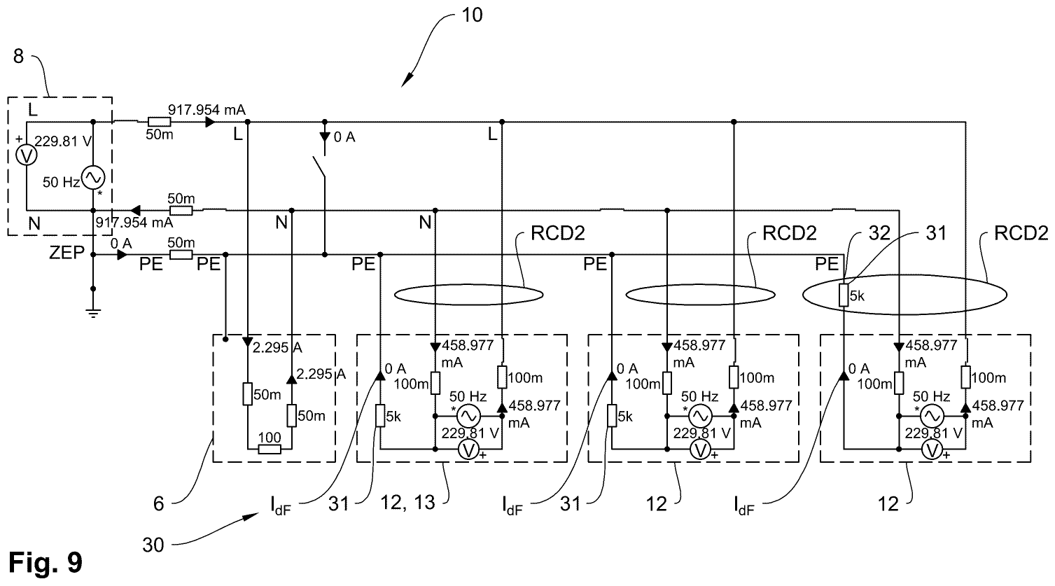

FIG. 9 shows the AC power supply system 10 in the event of a ground fault with the protective device in the second embodiment 30 as intended by the present disclosure during the main supply 8 and when supplied by additional power sources 12.

This operating state represents normal operation of the fault-free power supply system 10 with active main supply 8 and when supplied by additional power sources 12. The diagram shows that, as expected, the corresponding residual differential current I_{dF} at the additional power sources 12 is 0 A.

The residual current device RCD2 at the additional power source 12 shown on the far right is designed exemplarily as a modified residual current device RCD2 and includes the measuring impedance 31 and the protective conductor connection 32 as integral components.

What is claimed is:

1. A protective device for protection against electric shock in an AC, 3AC or DC power supply system comprising a main supply and additional power sources, an N conductor or an M conductor being connected to a protective conductor (PE) with low resistance at the main supply, the protective device comprising:
a voltage measuring device switched between the N conductor or M conductor and the protective conductor (PE) at each of the additional power sources and configured to measure an N-conductor-to-protective-conductor voltage (U_{N-PE}) or an M-conductor-to-protective-conductor voltage (U_{M-PE}); and
a signaling device disposed at each of the additional power supplies and configured to signal when a voltage has been exceeded via a disconnect signal when the N-conductor-to-protective-conductor voltage (U_{N-PE}) or the M-conductor-to-protective-conductor voltage (U_{M-PE}) exceeds a voltage threshold at a corresponding one of the additional power supplies.

2. The protective device according to claim 1, further comprising:
a disconnect device disposed at each of the additional power supplies and is connected to the corresponding signaling device in order to receive the disconnect signal.

3. A protective device for protection against electric shock in an AC, 3AC or DC power supply system comprising a main supply and additional power sources, an N conductor or an M conductor being connected to a protective conductor (PE) with low resistance at the main supply, the protective device comprising:
a residual current device (RCD2) disposed at each of the additional power sources and configured to identify a corresponding residual differential current (I_{dF}),
wherein a measuring impedance switched between the N conductor or the M conductor and the protective device at each of the additional power sources and configured to generate the residual differential current (I_{dF}) caused by an N-conductor-to-protective-conductor voltage (U_{N-PE}) or an M-conductor-to-protective-conductor voltage (U_{M-PE}).

4. The protective device according to claim 3, wherein the measuring impedance and a protective-conductor connection are integral components of the residual-current device (RCD2).

5. The protective device according to claim 3, wherein the measuring impedance is greater than a fault-loop impedance and less than a quotient derived from an admissible touch voltage (U_{B}) and a nominal tripping current of the residual current device (RCD2).

6. The protective current device according to claim 3, wherein a time-slot control cyclically activates the measuring impedances in temporal intervals.

7. A method for protection against electric shock in an AC, 3AC or DC power supply system having a main supply and additional power sources, an N conductor or an M conductor being connected to a protective conductor (PE) with low resistance at the main supply, the method comprising:
measuring an N-conductor-to-protective-conductor voltage (U_{N-PE}) or an M-conductor-to-protective-conductor voltage (U_{M-PE}) via a voltage measuring device switched between the N conductor or the M conductor and the protective conductor (PE); and
signaling when a voltage is exceeded via a disconnect signal via a signaling device disposed at each of the additional power sources when the N-conductor-to-protective-conductor voltage (U_{N-PE}) or the M-conductor-to-protective-conductor voltage (U_{M-PE}) exceeds a voltage threshold at the respective additional power source.

8. The method according to claim 7, further comprising disconnecting the corresponding additional power source via a disconnect device disposed at each of the additional power sources and connected to the corresponding signaling device to receive the disconnect signal.

9. A method for protection against electric shock in an AC, 3AC or DC power supply system having a main supply and additional power sources, an N conductor or an M conductor being connected to a protective conductor (PE) with low resistance at the main supply, the method comprising:
generating a residual differential current (I_{dF}) caused by an N-conductor-to-protective-conductor voltage (U_{N-PE}) or an M-conductor-to-protective-conductor voltage (U_{M-PE}) via a measuring impedance (31) switched between the N conductor or the M conductor and the protective conductor (PE) at the corresponding additional power sources; and
disconnecting the additional power source via a residual current device (RCD2) disposed at the corresponding additional power sources and intended for identifying the corresponding residual differential current (I_{dF}).

10. The method according to claim 9, wherein the residual differential current (I_{dF}) is generated with the measuring impedance, and wherein the measuring impedance and a protective-conductor connection are integral components of the residual current device (RCD2).

11. The method according to claim 9, wherein the residual differential current (I_{dF}) is generated with the measuring impedance which is greater than a fault-loop impedance and less than a quotient derived from an admissible touch voltage and a nominal tripping current of the residual current device (RCD2).

12. The method according to claim 9, further comprising cyclically activating the measuring impedances in temporal intervals via a time-slot control.
